(19) United States
(12) Patent Application Publication
(10) Pub. No.: US 2009/0290343 A1
(43) Pub. Date: Nov. 26, 2009

(54) LIGHTING FIXTURE

(75) Inventors: JEFFREY ALAN BROWN, AUSTELL, GA (US); LESLIE CHARLES KING, LOGANVILLE, GA (US); DAVID CLIFTON, CONYERS, GA (US)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: ABL IP HOLDING INC.

(21) Appl. No.: 12/470,021

(22) Filed: May 21, 2009

Related U.S. Application Data
(60) Provisional application No. 61/055,537, filed on May 23, 2008.

(51) Int. Cl. F21V 1/00; H01J 9/24

(52) U.S. Cl. 362/235; 445/23; 362/294

(57) ABSTRACT

Embodiments of the invention provide lighting assemblies for installation in lighting fixtures. Lighting assemblies include at least one light source, at least one heat sink, and at least one reflector. Other embodiments of the lighting assembly may also include an outer surface of the reflector comprising a heat sink. In some embodiments, it may be desirable to direct light toward a wall. In those situations, a wall wash trim may be included. The lighting assemblies disclosed herein may be modular and thus replaced without having to uninstall the entire fixture. In some embodiments, a circuit board containing at least one light emitting diode in an existing lighting assembly may be replaced with another circuit board containing light emitting diodes of a different color temperature or a different color.

### CROSS-REFERENCE TO RELATED APPLICATIONS

This application claims the benefit of U.S. Provisional Application No. 61/055,537, entitled “Led Dome Downlight With Circular LED Ring And Associated Heat Sink” and filed May 23, 2008, the entirety of which is incorporated herein by reference.

### FIELD OF THE INVENTION

Embodiments of the invention relate to lighting fixtures.

### BACKGROUND OF THE INVENTION

Traditional recessed light or down light fixtures include a metal cylinder that is mounted in the ceiling and that contains a light socket. An incandescent or fluorescent bulb is typically mounted in the light socket to provide the desired illumination. Such bulbs are inefficient and have a relatively short lamp life. Thus, efforts have been made to identify suitable alternative illumination sources for recessed lighting applications. Light emitting diodes (“LEDs”) have been identified as one alternative to traditional incandescent and fluorescent bulbs.

LEDs are extremely efficient, and their efficiency is rapidly improving. For example, the lumen output obtained by 20 LEDs may soon be obtained by 10 LEDs. Thus, the technology of LEDs is progressing such that the same light level may be obtained by fewer LEDs and thus less energy expenditures. Given the benefits of LEDs, one would think that consumers would simply select LED fixtures and upgrade the LEDs as more efficient ones become available. However, in comparison to simply changing a light bulb in a conventional lighting fixture, updating an existing LED fixture with more efficient LEDs can be labor intensive and costly. Such replacement typically requires access to the area above the ceiling. Environmental concerns, such as asbestos contamination and asbestos removal, become an issue when disturbing the ceiling. Moreover, the area above the ceiling collects dirt and dust, which can dislodge during LED replacement and thereby increase the time and cost of clean-up after installation. Additionally, exposed electrical wiring is common in such areas, which creates a safety hazard for workers removing old fixtures. A licensed electrician may be required to install the new fixtures based upon common safety codes. Thus, consumers are reticent to invest in an LED fixture today if the LEDs will quickly become obsolete and they cannot easily replace them with more efficient LEDs. As a result, consumers defer entirely from transitioning to a much more efficient light source. Therefore, there exists a need for an LED lighting fixture that can be quickly and easily upgraded.

### SUMMARY OF EMBODIMENTS OF THE INVENTION

Embodiments of the invention provide lighting assemblies for recessed lighting, but may be used in lighting fixtures of any type. In one embodiment, lighting assemblies include a plurality of light sources, such as light emitting diodes, a heat sink, and a reflector. Light emitting diodes may be mounted on a printed circuit board, which is then mounted on the heat sink. The reflector is positioned over the printed circuit board and also mounted to the heat sink. The reflector preferably has an inner surface with an extremely high surface reflectivity. An outer surface of the reflector may comprise a heat sink to further enhance heat dissipation.

The lighting assembly may be installed in a recessed lighting fixture or other suitable lighting installation. In these embodiments, the lighting assembly is connected to a mounting pan, which includes a base portion, a draw down, and an aperture. The lighting assembly is positioned over the mounting pan aperture. A trim piece, which also has a highly reflective surface, is positioned in the draw down. Light emitted from the light emitting diodes encounters and reflects off the reflector's reflective inner surface, where it is mixed in the reflector cavity and emitted through the mounting pan aperture and further reflected by the trim piece surface. In yet other embodiments, an inner reflector is inserted into the trim piece to partially obscure the trim piece's reflective surface. The combination of trim piece and inner reflector is referred to as a wall wash trim. The light encounters the exposed portion of the trim piece, where the trim piece then directs the light towards a wall.

Some embodiments of the present invention enable easy upgradeability. The lighting assembly may be removed through the mounting pan aperture without un-installing the entire lighting fixture from the ceiling. After removal, an entirely new lighting assembly may be installed or the existing lighting assembly may be upgraded by replacing the circuit board with a new circuit board containing the desired light emitting diodes.

### BRIEF DESCRIPTION OF THE DRAWINGS

FIG. 1 is an exploded view of a heat sink and circuit board according to one embodiment of the present invention.

FIG. 2 is a top perspective view of a heat sink according to an alternative embodiment of the present invention.

FIG. 3 is a top perspective view of a heat sink according to an alternative embodiment of the present invention.

FIG. 4 is a top perspective view of an assembled heat sink and circuit board with an exploded view of a reflector according to one embodiment of the present invention.

FIG. 5 is a top perspective view of an assembled heat sink and reflector according to one embodiment of the present invention.

FIG. 6 is a top perspective view of an assembled heat sink and reflector according to an alternative embodiment of the present invention.

FIG. 7 is a top perspective view of an assembled heat sink and circuit board with an exploded view of a reflector and reflective liner according to one embodiment of the present invention.

FIG. 8 is a top perspective view of a reflector with an outer surface comprising a heat sink according to an alternative embodiment of the present invention.

FIG. 9 is a top perspective view of a reflector with an outer surface comprising a heat sink according to another alternative embodiment of the present invention.

FIG. 10 is an exploded view of a lighting fixture.

FIG. 11 is a bottom perspective view of a trim piece positioned in a mounting pan draw down.

FIG. 12 is a cross-sectional view of a lighting fixture showing reflection of light through a heat sink, mounting pan aperture, and trim piece.

FIG. 13 is a top perspective view of an inner reflector.

FIG. 14 is a top perspective view of the inner reflector of FIG. 13 positioned in a trim piece.

FIG. 15 is a bottom plan view of the inner reflector of FIG. 13 positioned in a trim piece.

FIG. 16 shows a method of removing modular components associated with a lighting fixture.

FIG. 17 is a bottom perspective view of an assembled lighting fixture according to another embodiment of the present invention.

### DETAILED DESCRIPTION OF EMBODIMENTS OF THE INVENTION

Embodiments of the invention provide lighting assemblies for installation in lighting fixtures. While the lighting assemblies are discussed for use with recessed lighting fixtures, they are by no means so limited. Rather, embodiments of the LED lighting assemblies may be used in lighting fixtures of any type.

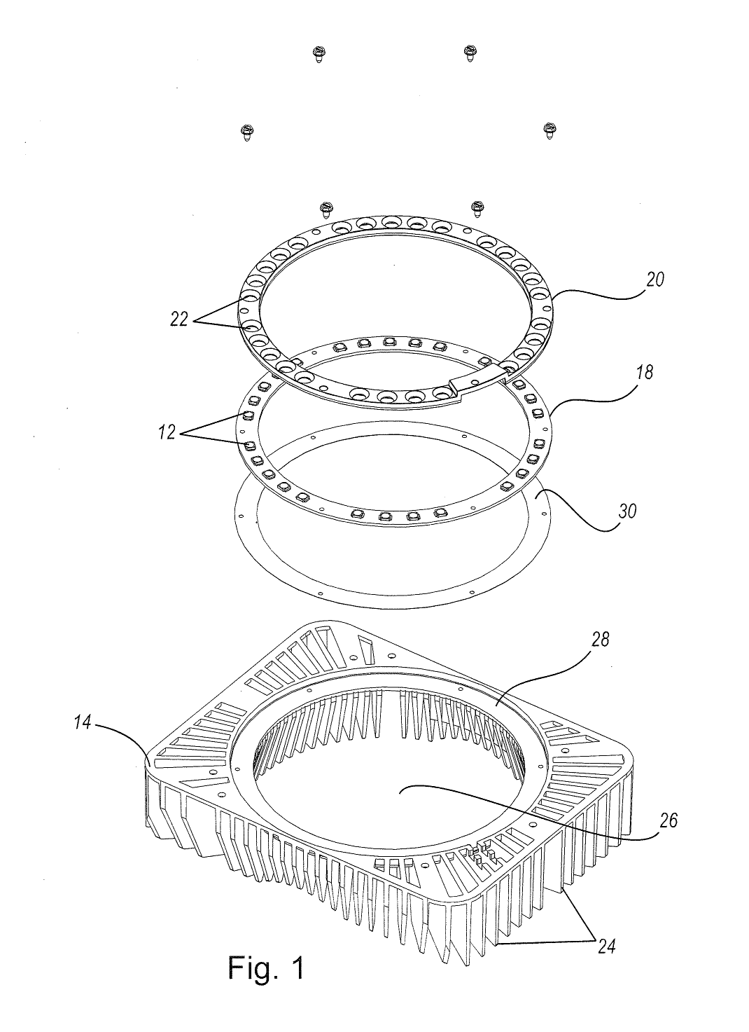

FIGS. 1, 4, and 5 illustrate one embodiment of a lighting assembly 10. Lighting assembly 10 includes a plurality of light sources 12, a heat sink 14, and a reflector 16. In one embodiment, light sources 12 are solid state light sources such as light emitting diodes (“LEDs”). For ease of discussion, light sources 12 are referred to generally as LEDs 12. However, other light sources may be used. Moreover, LEDs 12 referenced herein can be single-die or multi-die light emitting diodes, DC or AC, or can be organic light emitting diodes (“O-LEDs”). Lighting assemblies 10 need not use only white LEDs 12. Rather color or multicolor LEDs 12 may be provided. Nor must all of the LEDs 12 within a lighting assembly 10 be the same color.

LEDs 12 are mounted on a printed circuit board 18 (“PCB”). PCB 18 can be, among other things, metal core board, FR4 board, CHMI board, etc. Any number of LEDs 12 may be mounted on PCB 18 at any number of locations. In one embodiment, an array of LEDs 12 are mounted on PCB 18 in a ring-like formation. In another embodiment, LEDs 12 are evenly distributed around a rectangular shaped PCB 18. While certainly not required, positioning LEDs 12 in an evenly distributed pattern (as opposed to the typical clustering of LEDs) creates more space between LEDs 12. An even distribution of LEDs 12 also creates a more uniform heat distribution across the surface of heat sink 14, thus resulting in more efficient heat removal. As a result, more LEDs can be used and the resulting lumen package is comparable to a conventional light source (e.g., 32 watt TRT lamp).

To protect LEDs 12 from damage, an annular protective cover 20 may be, but does not have to be, placed over PCB 18. If used, protective cover 20 contains LED apertures 22, which are aligned with the location of LEDs 12 to allow the emitted light from LEDs 12 to pass through protective cover 20. The cover may be formed from a flame-resistant nylon resin UV stable material, such as DuPont Zytel®) nylon, or similar material.

To further facilitate thermal management of PCB 18, a heat sink 14 with radial fins 24 is mounted onto the underside of PCB 18. Heat sink 14 preferably includes a heat sink aperture 26. While the illustrated heat sink aperture 26 is round, one of skill in the art will understand that heat sink aperture 26 may be any shape. Heat sink 14 may, but does not have to, include a recessed groove 28 shaped to receive PCB 18 (in the illustrated embodiments, an annular recessed groove 28). Groove 28 allows PCB 18 to be positioned on heat sink 14 to ensure maximum contact between PCB 18 and heat sink 14. A thermally conductive gasket 30 may be, but does not have to be, located between PCB 18 and heat sink 14. Gasket 30 may reduce thermal resistance between PCB 18 and heat sink 14, resulting in better conductivity and heat transfer. Gasket 30 may be formed from thermally conductive, silicone-coated fabric, or other similar material. PCB 18 and heat sink 14 may be attached together with any suitable mechanical or chemical means. In one embodiment, mechanical fasteners are used to secure PCB 18 (as well as optional protective cover 20 and/or gasket 30) to heat sink 14.

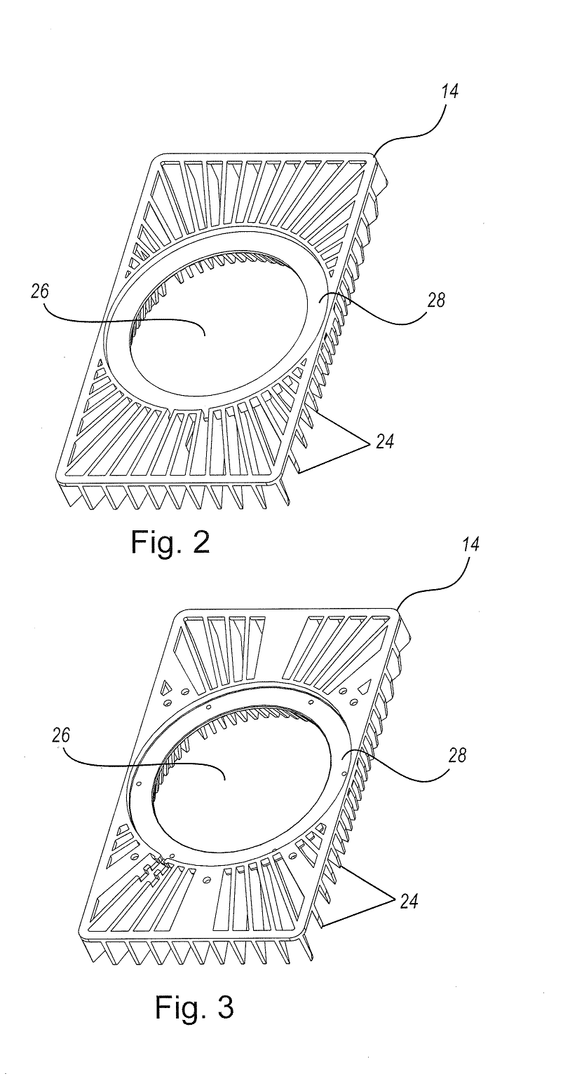

In use, heat generated by LEDs 12 is dissipated via heat sink 14. While rectilinear embodiments of heat sinks 14 are illustrated (see FIGS. 1-3), heat sink 14 may assume any shape (circular, square, rectangular, oblong, triangular, etc.). The shape of heat sink 14 may be dimensioned to enhance the modularity of lighting assembly 10, as discussed in more detail below. While more fins 24 increase the surface area available for heat transfer and consequently the heat transfer coefficient, any number of fins 24 may be positioned in any configuration, pattern, orientation, and location on heat sink 14. Fins may be formed from die cast aluminum, or similar material. Fins 24 may utilize natural convection or active cooling techniques (including fans or other means) to transfer heat away from fins 24. In some embodiments, active air cooling devices, such as fans, cause air to move over fins 24 and carry heat away from the lighting fixture. In other embodiments, heat is transferred away from fins 24 through passive cooling systems, such as where the heat dissipates through natural convection.

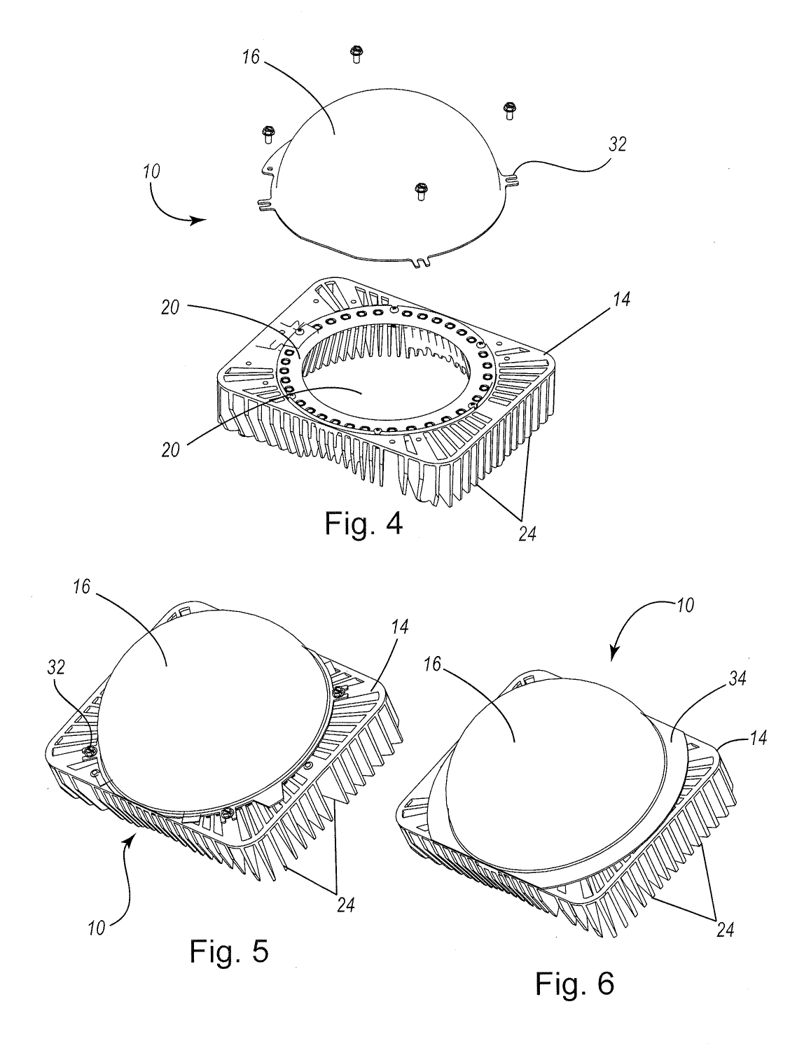

As illustrated in FIGS. 4-7, reflector 16 is positioned over PCB 18 and mounted to heat sink 14. While the illustrated reflector 16 has a dome shape, the reflector may have any shape, including, but not limited to, rectilinear, frustoconical, cylindrical, etc. In some embodiments, reflector 16 is formed from hydro-formed aluminum, or other similar material. In other embodiments, reflector 16 is formed from die-cast aluminum, or other similar material.

In some embodiments, reflector 16 includes tabs 32 (FIG. 5) or wings 34 (FIG. 6) through which mechanical fasteners extend to secure reflector 16 to heat sink 14. However, reflector 16 may be mounted to heat sink 14 in any suitable way.

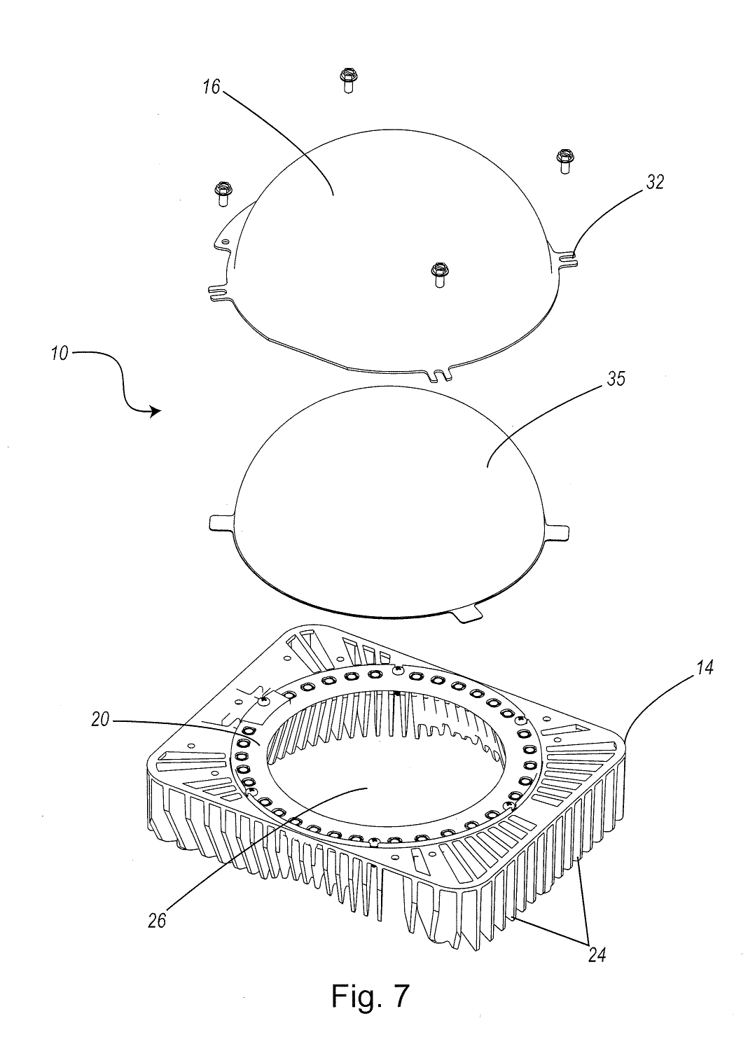

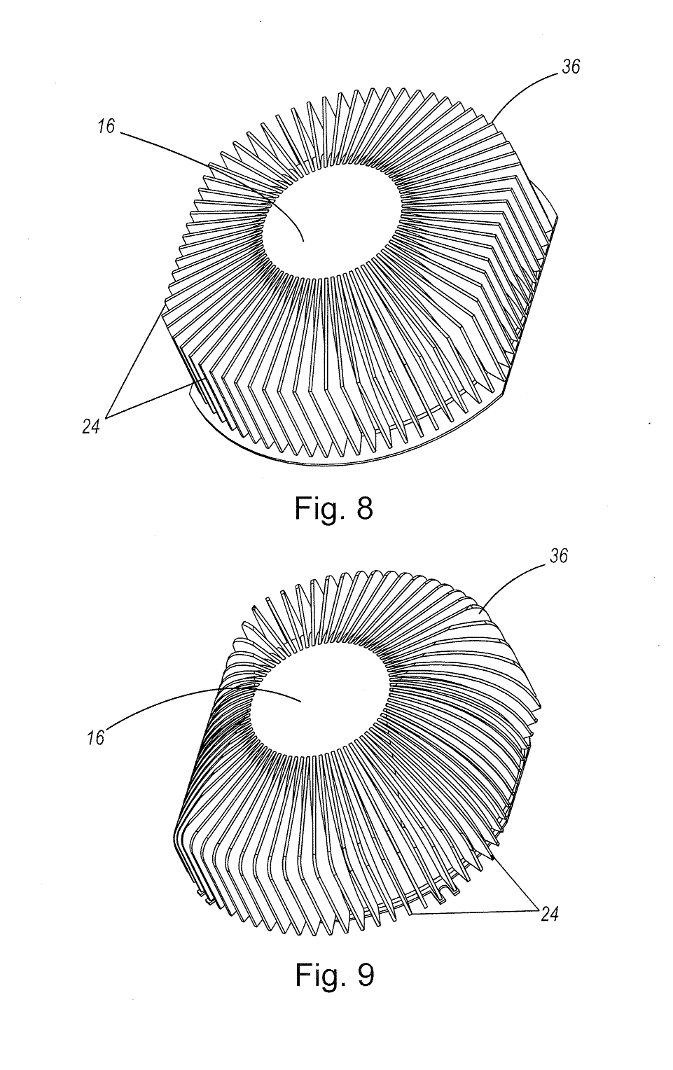

The inner surface of reflector 16 preferably has extremely high surface reflectivity, preferably, but not necessarily, between 96%-99.5%, inclusive and more preferably 98.5-99%. To achieve the desired reflectivity, in one embodiment the inner surface of reflector 16 is coated with a highly reflective material, including, but not limited to, paints sold under the tradenames GL-22, GL-80 and GL-30, all available from DuPont. Other embodiments may utilize textured or colored paints or impart a baffled shape to the reflector surface to obtain a desired reflection. Alternatively, a reflective liner 35, such as Optilon™ available from DuPont, may be positioned within reflector 16, as is illustrated in FIG. 7.

In other embodiments of the present invention, as illustrated in FIGS. 8-9, fins 24 may be provided on an outer surface of reflector 16 to further enhance heat dissipation. In this way, reflector 16 serves both as an optical reflector (discussed below) and as a heat sink 36. Any number of fins 24 may be positioned in any configuration, pattern, orientation, and location on reflector 16. In some embodiments, reflector 16 with heat sink 36 is formed from die cast aluminum, or other similar material.

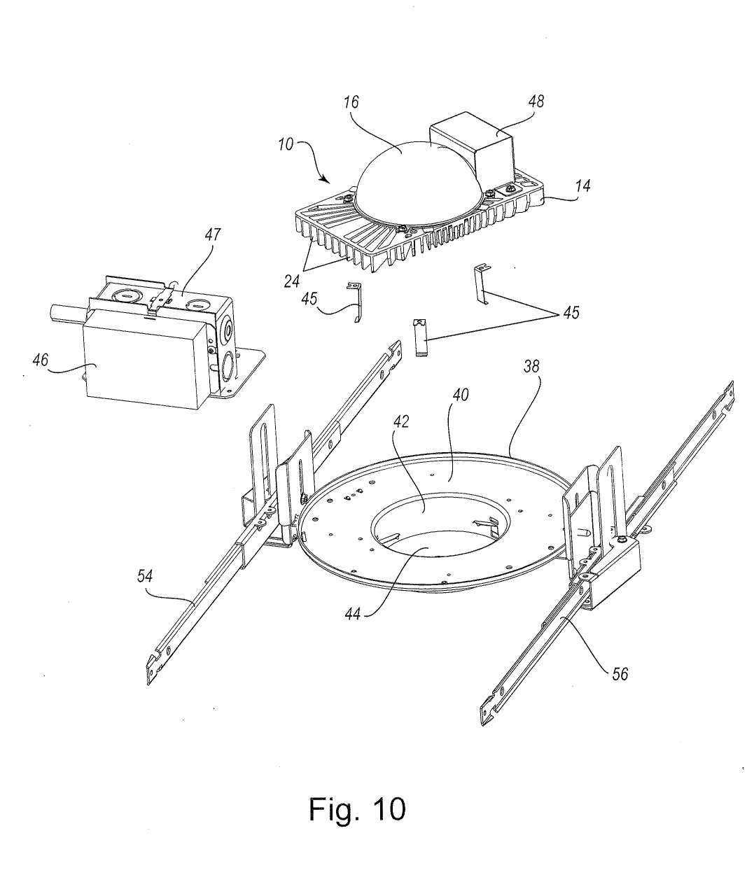

Lighting assembly 10 may be installed in a light fixture. For purposes of discussion, lighting assembly 10 is described for installation in a recessed lighting fixture. FIG. 10 depicts an exploded view of the components of lighting assembly 10 and one embodiment of a recessed light fixture. Lighting assembly 10 is positioned on a mounting pan 38. Mounting pan 38 typically includes a base portion 40 and a draw down 42. A mounting pan aperture 44 extends through base portion 40 and draw down 42. Mounting pan 38 may be made from any suitably rigid material, including metal, wood or plastic, and is preferably metal and more preferably steel.

Lighting assembly 10 is positioned so that fins 24 of heat sink 14 rest on the base portion 40 of mounting pan 38 and so that heat sink aperture 26 is positioned over mounting pan aperture 44. Lighting assembly 10 may be secured to mounting pan 38 by any suitable retention method. In one embodiment, lighting assembly 10 is secured to mounting pan 38 via clips 45 that may be riveted to heat sink 14 and snap onto mounting pan 38. However, one of skill in the art will understand that any type of fastener may be used and preferably, but not necessarily, is of a type that is capable of being repeatedly fastened and unfastened.

A driver 46 to power lighting assembly 10 is also provided and can be secured to mounting pan 38. In some embodiments, driver 46 is secured to a junction box 47. Junction box 47 and driver 46 may be positioned on a mounting bracket that is secured to base portion 40 of mounting pan 38. Leads from driver 46 are connected to leads from lighting assembly 10. In some embodiments, the lead connection is of a type that is capable of being repeatedly fastened and unfastened. However, one of skill in the art will understand that any type of lead connection may be used. The lead connection may be located in a splice box 48 that may be mounted in various locations in the lighting fixture. In one embodiment, splice box 48 is mounted on heat sink 14.

In typical recessed lighting situations, mounting pan 38 is suspended above a hole in the ceiling between adjacent ceiling joists in a conventional way (such as through the use of suspension bars 54, 56). It is preferable, but not required, that lighting assembly 10 be mounted on mounting pan 38 and all necessary splicing occur prior to suspension of mounting pan 38 in the ceiling.

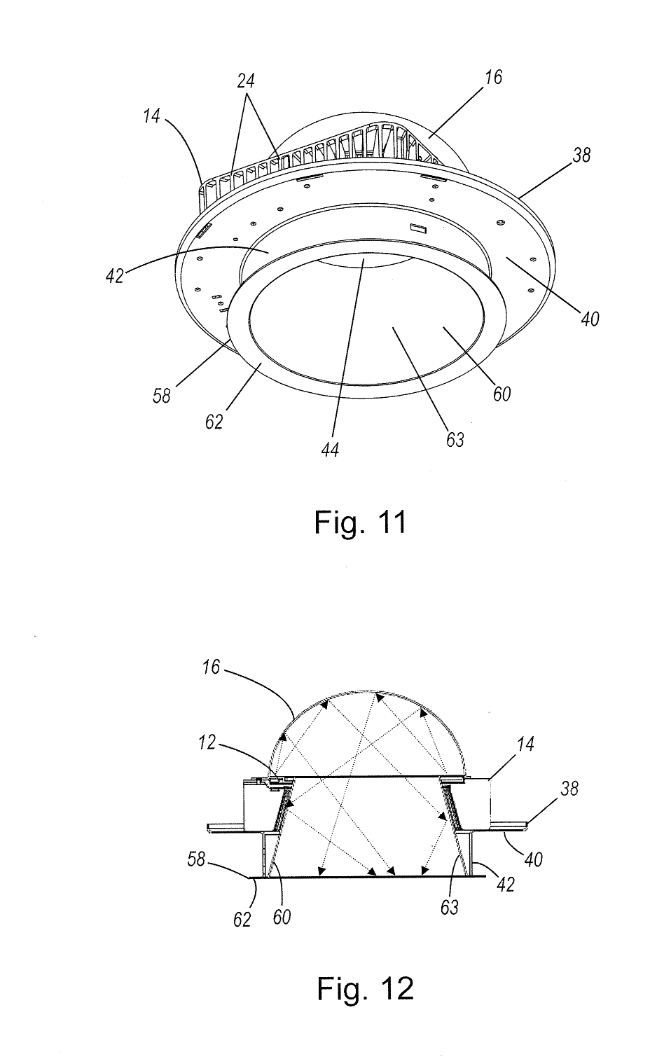

As illustrated in FIG. 11, a trim piece 58 is then inserted into mounting pan aperture 44 and connected to draw down 42 by interference fit or mechanical means. In one embodiment, retaining clips are located on draw down 42 to hold trim piece 58. Trim piece 58 includes a body 60 and a flange 62. When positioned within mounting pan aperture 44, flange 62 conceals the cut-out in the ceiling and thereby imparts a polished look to the lighting fixture installation. The top of trim body 60 may also at least partially conceal LEDs 12 from direct viewing of the light source.

The inner surface 63 of trim piece 58 preferably has extremely high surface reflectivity. To achieve the desired reflectivity, in one embodiment, inner surface 63 of trim piece 58 has an anodized finish or is otherwise treated (such as with a highly reflective paint) so as to enhance its reflectivity. In other embodiments, inner surface 63 of trim piece 58 is baffled to enhance its reflectivity. Trim piece 58 also controls the flash, so that an observer does not perceive a bright spot on the trim from a particular viewing angle.

In use, as illustrated in FIG. 12, the light from LEDs 12 is projected upwardly into the cavity defined by reflector 16. The light encounters and reflects off of the extremely reflective inner surface of reflector 16. In this way, the emitted light of the plurality of LEDs 12 is mixed in the cavity defined by reflector 16 and emitted as indirect, diffuse, uniform light through heat sink aperture 26, mounting pan aperture 44, and trim piece 58 positioned therein.

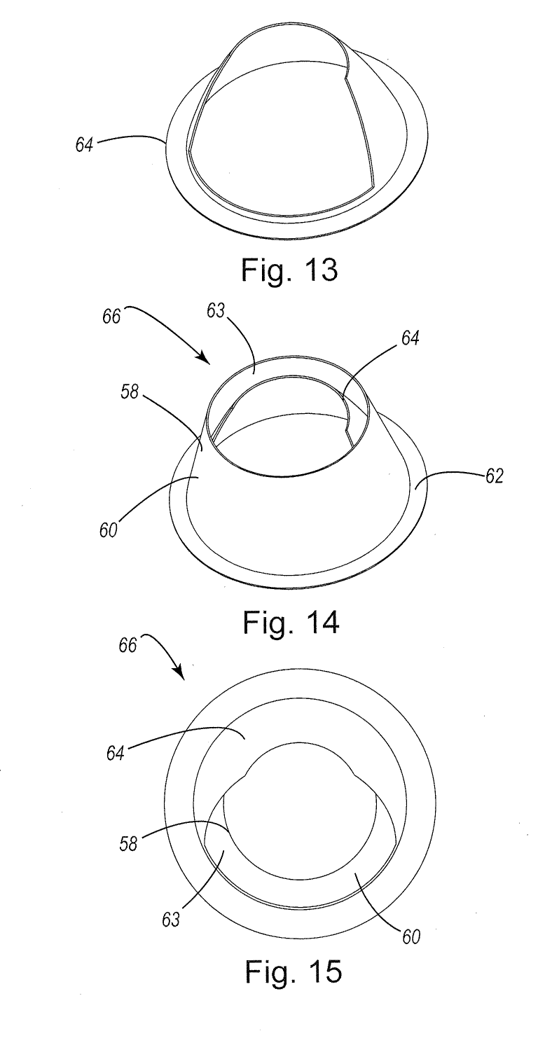

In yet other embodiments of the present invention, an inner reflector 64 (FIG. 13) is inserted into trim piece 58 (collectively, “wall wash trim 66”). As illustrated in FIGS. 14-15, inner reflector 64 is shaped so as not to cover the entirety of the inner surface 63 of trim piece 58 when inner reflector 64 is positioned within trim piece 58. Rather, a portion of the inner surface 63 of trim piece 58 remains exposed. In one intended use, wall wash trim 66 is preferably positioned within draw down 42 so that the exposed portion of trim piece 58 faces a wall. As described above, indirect light is supplied from LEDs 12 via reflector 16 and into wall wash trim 66. The light encounters the exposed portion of the highly reflective trim piece 58, which directs or “kicks” the light towards the wall. Via these two reflection steps, the emitted light can be focused to accent particular areas of a wall (e.g., on a painting hanging on the wall).

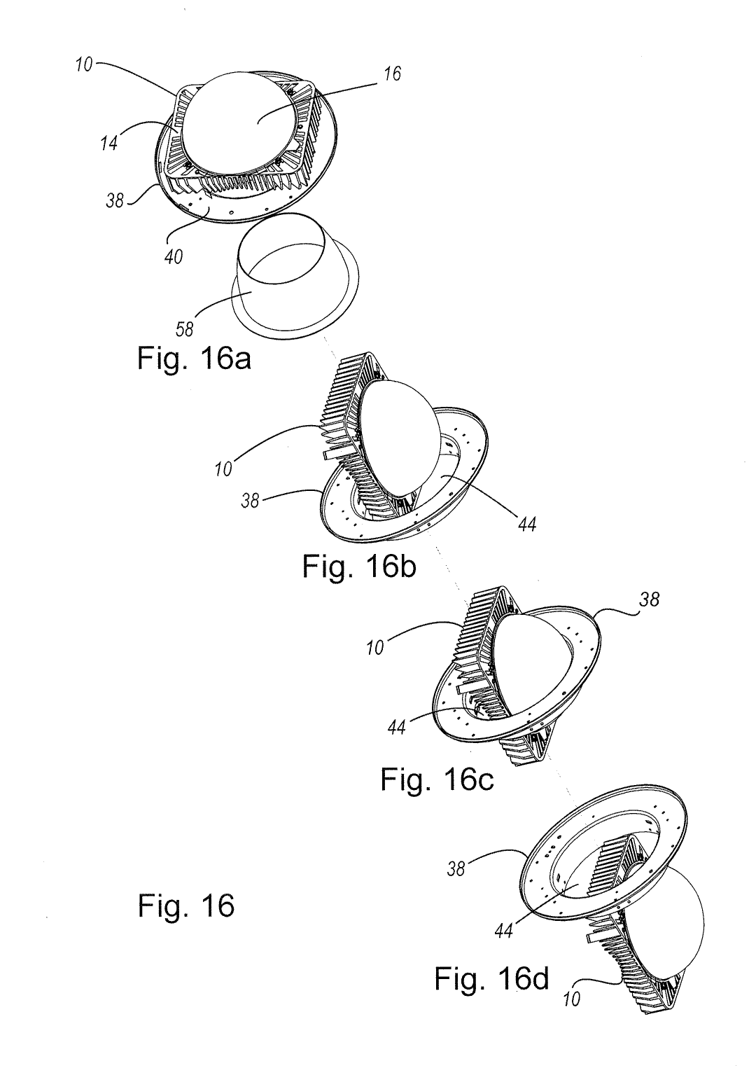

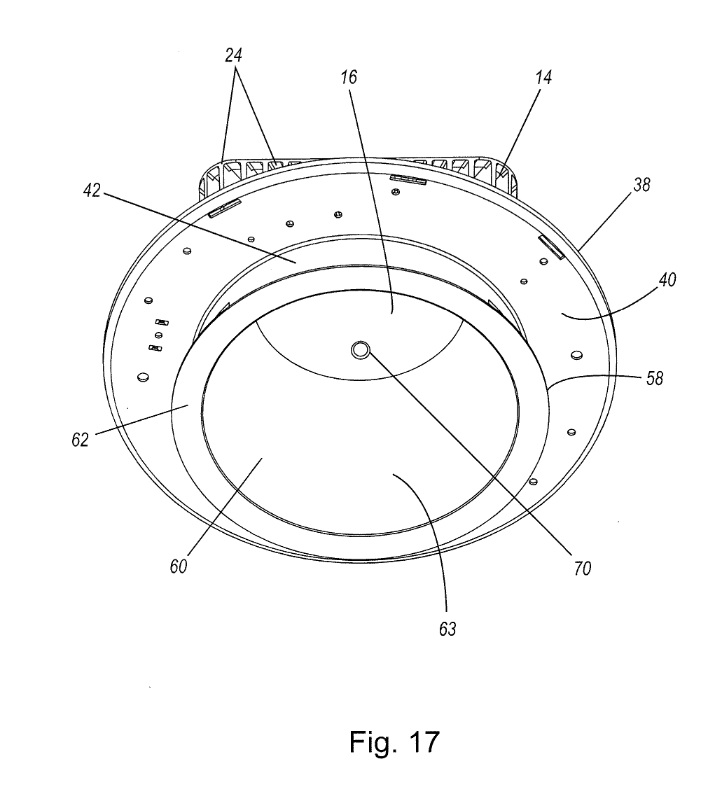

Some embodiments of the present invention enable easy upgradeability of existing LEDs 12 so that the lighting fixture may easily be updated, maintained, or tailored to impart improved efficiency or functionality without having to un-install the entire lighting fixture from the ceiling and without requiring ceiling access. As shown in FIG. 16a, trim piece 58 is first removed from draw down 42. Retaining clips or other mechanical devices that were used to secure trim piece 58 may also be removed from draw down 42.

Next, as shown in FIG. 16b, attachment clips or other fastening devices securing lighting assembly 10 to mounting pan 38 are disengaged so that lighting assembly 10 is separable from mounting pan 38. Lighting assembly 10 is rotated approximately 90 degrees into a substantially vertical position such that one end of lighting assembly 10 is positioned above mounting pan aperture 44. At that point, as shown in FIG. 16c, lighting assembly 10 is maneuvered through mounting pan aperture 44 until lighting assembly 10 substantially exits mounting pan aperture 44.

Once lighting assembly 10 substantially exits mounting pan aperture 44 below the ceiling, as shown in FIG. 16d, the leads from lighting assembly 10 are disconnected from the leads of driver 46. The leads from lighting assembly 10 and the leads from driver 46 may be disconnected via a lead connection that is capable of being repeatedly fastened and unfastened. However, one of skill in the art will understand that any type of lead connection may be used. The lead connection or other connection mechanism may be located within splice box 48.

In some embodiments, splice box 48 is separately mounted on mounting pan 38 so that splice box 48 is not removed with lighting assembly 10 and disconnection occurs inside the ceiling. In other embodiments, splice box 48 is mounted directly to heat sink 14, thus allowing splice box 48 to be removed along with lighting assembly 10 where disconnection may occur outside of the ceiling.

While a new lighting assembly 10 having the desired LEDs may then be easily installed in place of existing lighting assembly 10 (by simply reversing the above-described steps as described in detail below), in other embodiments, reflector 16, and optionally reflective liner 35, are removed from the existing lighting assembly 10 and PCB 18 is simply replaced with another PCB 18 having the desired LEDs 12. In this way and by way only of example, lighting assembly 10 may be easily updated to have more efficient LEDs, color and multi-color LEDs, or color-changing LEDs that could use industry standard controllers to control the color and rate of change for LEDs 12. PCB 18 can simply be replaced with a ring of different color temperature or different colored LEDs. Once PCB 18 has been replaced, reflector 16 and optional reflective liner 35 are then re-connected to heat sink 14.

After reflector 16 has been reconnected to heat sink 14, lighting assembly 10 is installed back in the ceiling. The leads from lighting assembly 10 are connected to driver 46 and lighting assembly 10 is then maneuvered through mounting pan aperture 44 and rotated to rest on the mounting pan 38. Attachment clips or other fastening devices securing lighting assembly 10 to mounting pan 38 are engaged so that lighting assembly 10 is secured to mounting pan 38. Retaining clips or other mechanical devices may be installed in draw down 42 to secure trim piece 58. Trim piece 58 may then be connected to draw down 42.

In some embodiments, driver 46 may also require replacement. Following the steps to remove lighting assembly 10 described above, driver 46 may then be accessed through mounting pan aperture 44. Driver 46 is disconnected from mounting pan 38 and replaced with a new driver 46 to achieve the desired LED output. Following replacement of driver 46, lighting assembly 10 (new or existing) is re-installed following the steps described above.

This design offers the standard battery backup for emergency lighting, or EL, options that are required by law. In some embodiments of the present invention, as shown in FIG. 17, an illuminated test button 70 is mounted inside reflector 16, where it is accessible and depressible from the room in order to check the status of the emergency lighting battery.

The foregoing is provided for purposes of illustrating, explaining, and describing embodiments of the present invention. Further modifications and adaptations to these embodiments will be apparent to those skilled in the art and may be made without departing from the scope or spirit of the invention.

We claim:

1. A lighting fixture comprising:
a. a lighting assembly comprising:
i. at least one heat sink;
ii. at least one reflector mounted on the heat sink; and
iii. a plurality of light sources supported on the heat sink, wherein the plurality of light sources are positioned to emit light towards the reflector; and
b. a mounting pan for supporting the lighting assembly.

2. The lighting fixture of claim 1, wherein the reflector is substantially dome-shaped.

3. The lighting fixture of claim 1, wherein the plurality of light sources comprises light emitting diodes.

4. The lighting fixture of claim 3, wherein the light emitting diodes are arranged in a circular pattern.

5. The lighting fixture of claim 3, wherein the light emitting diodes are positioned on a first side of a printed circuit board.

6. The lighting fixture of claim 5, wherein the lighting assembly further comprises a cover positioned on the first side of the printed circuit board.

7. The lighting fixture of claim 5, wherein a second side of the printed circuit board faces the heat sink.

8. The lighting fixture of claim 7, wherein the lighting assembly further comprises a thermally conductive material positioned between the second side of the printed circuit board and the heat sink.

9. The lighting fixture of claim 1, wherein an outer surface of the reflector comprises a heat sink.

10. The lighting fixture of claim 1, wherein an inner surface of the reflector has a surface reflectivity of at least 98%.

11. The lighting fixture of claim 1, wherein the lighting assembly further comprises a reflective liner positioned adjacent an inner surface of the reflector.

12. The lighting fixture of claim 1, wherein the lighting assembly further comprises an emergency test button accessible on an inner surface of the reflector.

13. The lighting fixture of claim 1, wherein the mounting pan further comprises:
a. a base portion;
b. a mounting pan aperture; and
c. a draw down.

14. The lighting fixture of claim 13, wherein the heat sink further comprises a heat sink aperture, and wherein the heat sink aperture and the mounting pan aperture align when the lighting assembly is supported by the mounting pan.

15. The lighting fixture of claim 13, further comprising at least one trim piece retained in the mounting pan draw down.

16. The lighting fixture of claim 15, wherein an inner surface of the trim piece is treated to enhance its reflectivity.

17. The lighting fixture of claim 15, further comprising an inner reflector positioned adjacent an inner surface of the trim piece, wherein a portion of the inner surface of the trim piece remains exposed when the inner reflector is positioned adjacent the inner surface of the trim piece.

18. A method of replacing an existing lighting assembly with a replacement lighting assembly through an aperture in a mounting pan located in a ceiling, the replacement lighting assembly comprising (i) at least one heat sink; (ii) at least one reflector mounted on the heat sink; and (iii) a plurality of light sources supported on the heat sink, wherein the plurality of light sources are positioned to emit light towards the reflector, the method comprising:
a. removing the existing lighting assembly through the mounting pan aperture;
b. disconnecting the existing lighting assembly from a power source;
C. providing the replacement lighting assembly;
d. inserting the replacement lighting assembly into the ceiling through the mounting pan aperture; and
e. connecting the replacement lighting assembly to the power source.

19. The method of claim 18, wherein providing the replacement lighting assembly comprises replacing a light source in the existing lighting assembly with the plurality of light sources of the replacement lighting assembly.

20. The method of claim 19, wherein the plurality of light sources of the replacement lighting assembly comprise light emitting diodes.
